(19) United States
(12) Patent Application Publication
(10) Pub. No.: US 2025/0327744 A1
(43) Pub. Date: Oct. 23, 2025

(54) Infrared absorption gas analyzer with dynamic pressure sampling

(71) Applicant: Martin L. Spartz, Ellington, CT (US)

(72) Inventor: Martin L. Spartz, Ellington, CT (US)

(21) Appl. No.: 19/173,403

(22) Filed: Apr. 8, 2025

Related U.S. Application Data
(60) Provisional application No. 63/635,279, filed on Apr. 17, 2024.

(51) Int. Cl. G01N 21/3504; G01N 1/22

(52) U.S. Cl. CPC G01N 21/3504; G01N 1/2273; G01N 2001/2282; G01N 2201/0231; G01N 2201/0636

(57) ABSTRACT

A gas analyzer system overcomes previous limitations through the use of dynamic pressure sampling. The system includes a gas cell, which is designed to hold the gas sample for analysis, and a piston pump that pressurizes the sample. The system strategically manipulates the pressure of the gas sample before and/or in the gas cell, thereby reducing the amount of water vapor present and minimizing its interference with the infrared absorption analysis. It leverages on the principles of physics and atmospheric science to adjust the pressure of the gas sample, factoring in the pressure and moisture content of the original ambient air, and the desired pressure within the cell for optimal analysis.

### RELATED APPLICATIONS

This application claims the benefit under 35 USC 119(e) of U.S. Provisional Application No. 63/635,279, filed on Apr. 17, 2024, which is incorporated herein by reference in its entirety.

### BACKGROUND OF THE INVENTION

Traditional methods of gas analysis, specifically, the analysis of gas samples using infrared absorption, such as Fourier Transform Infrared (FTIR) spectrometry, often struggle with interference from water vapor present in the gas sample. This interference can obscure spectral features of interest, limiting the effectiveness of the analysis. The challenge is particularly pronounced when attempting to analyze ambient air, which commonly contains around 1% water vapor or more. Ambient air, which is often the focus of analysis for first responders and military personnel seeking to detect chemical warfare agents, is difficult given the typical levels of water vapor. This level of water vapor can significantly interfere with the infrared absorption analysis, preventing accurate detection and identification of potentially harmful substances.

Additionally, most FTIR systems on the market today utilize gas cells of considerable optical length (5 to 40 meters (m) in multipass arrangements), which further exacerbates the issue of water vapor interference. This design feature, while beneficial in certain respects, further exacerbates the issue of water vapor interference. The longer the gas cell, the more water vapor absorption occurs, and the greater the interference with the spectral features of the gas being analyzed.

### SUMMARY OF THE INVENTION

There is a need for a gas analyzer that can conduct analysis of ambient air for trace species of interest while effectively mitigating the effects of water vapor interference. Such an analyzer would enable more accurate and reliable analysis of gas samples, particularly in scenarios where rapid and accurate detection of hazardous substances is crucial, such as in the case of first responders at an incident site or soldiers on a battlefield. Moreover, the system should preferably be low cost and mechanically robust.

Aspects of the present invention relate to a novel gas analyzer system that overcomes some or all of these limitations through the use of dynamic pressure sampling. The system includes a gas cell, which is designed to hold the gas sample for analysis, and a pump that pressurizes the sample. The system strategically manipulates the pressure of the gas sample before and/or in the gas cell, thereby reducing the amount of water vapor present and thus minimizing its interference with the infrared absorption analysis. It leverages on the principles of physics and atmospheric science to adjust the pressure of the gas sample, factoring in the moisture content of the original ambient air, and then modulates the pressure within the cell for robust analysis.

Aspects of the present invention provide an infrared absorption gas analyzer system capable of significantly reducing water vapor interference during the analysis of ambient air samples. The system employs a gas cell configured to hold the gas sample under controlled conditions and incorporates a pressure modulation device, such as a pump, to pressurize the gas sample dynamically. A condenser is arranged downstream of the pump to cool the pressurized gas, promoting condensation and facilitating the removal of excess water vapor. By strategically adjusting and stabilizing the pressure of the gas sample, the analyzer effectively minimizes the spectral interference typically caused by water vapor, thereby enhancing the accuracy and reliability of the infrared absorption measurements.

In specific embodiments, the gas cell comprises two elongated gas cell tubes optically coupled by an end reflector, enabling infrared radiation emitted from an infrared source of a spectrometer to propagate axially through the first gas cell tube, reflect off the end reflector, and then propagate axially through the second gas cell tube toward a detector. This configuration optimizes the optical path length and ensures consistent spectral quality.

Embodiments further provide precise temperature control within the gas cell using a temperature controller and associated temperature sensors. This temperature regulation ensures the gas sample remains above the dew point to prevent undesirable condensation within the gas cell during spectral measurement, maintaining the integrity of the infrared absorption data.

Additionally, the condenser can be specifically designed with a central tube through which the pressurized gas flows, surrounded by a cooling jacket that effectively reduces the temperature of the gas. The cooling jacket's controlled operation induces water vapor condensation onto the interior surfaces of the central tube, where it is selectively removed through a drain valve. The drain valve maintains the elevated pressure within the condenser, thereby ensuring consistent condensation efficiency and stable operating conditions.

To facilitate accurate spectral analysis, the system can include input and backpressure valves positioned at the gas cell's inlet and outlet, respectively. These valves cooperatively regulate gas flow and precisely maintain the predetermined analysis pressure within the gas cell. Moreover, the system can utilize a zero gas source to supply a zero-reference gas through the condenser and gas cell, thereby allowing the spectrometer to obtain a reliable background infrared absorption spectrum at conditions substantially matching the pressure and moisture saturation of subsequent sample measurements.

In one mode of operation, at least some water is retained in the condenser from the pressurization of the sample gas. In the process of passing the zero gas through the condenser, the zero gas acquires the same level of moisture as the sample due to the water retained in the condenser. The spectra of this zero gas with the added water is captured as a background. Thus, when the absorbance spectrum of the sample is calculated by reference to the background, the water is effectively removed from the spectrum since it is part of the background.

Methods disclosed herein involve pressurizing ambient air samples to elevated pressures sufficient to induce water vapor condensation, followed by removal of the condensed water vapor and subsequent reduction of gas pressure to a stabilized analysis pressure. This stabilized pressure is specifically selected to minimize residual water vapor interference during infrared spectral analysis, allowing trace gas analytes to be accurately detected and quantified. Further, matching the water vapor partial pressure between background and sample spectra significantly reduces spectral artifacts, improving detection limits and analytical accuracy.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1A is a schematic diagram of a gas analyzer according to the present invention.

FIG. 1B is a schematic diagram of a gas analyzer according to another embodiment.

FIG. 1C is a schematic diagram of a gas analyzer according to another embodiment.

FIG. 2 shows a spectrum extending from 600 to 5000 cm-1 for a sample with 1% moisture or water in a 5 m sample cell, 5%*m.

FIG. 3 shows a spectrum extending from 600 to 5000 cm-1 for a sample with 1%*m of moisture or water.

FIG. 4 shows a spectrum extending from 600 to 5000 cm-1 for a sample with moisture or water of 0.1%*m on the same scale.

FIG. 5 shows a spectrum extending from 600 to 5000 cm-1 for a sample with CO₂ at 400 ppm in ambient air (common now), at 10 atmospheres (atm) with a 1 m pathlength, that would be 4,000 ppm*m.

FIG. 6 shows a spectrum extending from 600 to 5000 cm-1 for a sample with CO₂ at 400 ppm in ambient air with the Y-scale of the spectrum expanded by 20-fold.

FIG. 7 is a schematic diagram of a gas analyzer system for stack monitoring according to the present invention.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

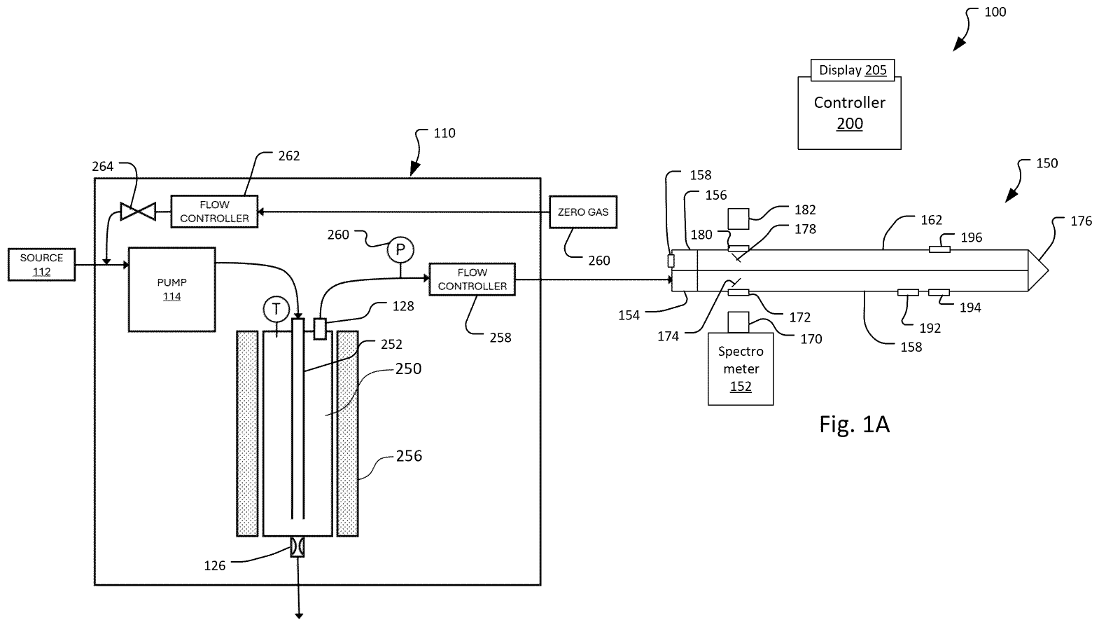

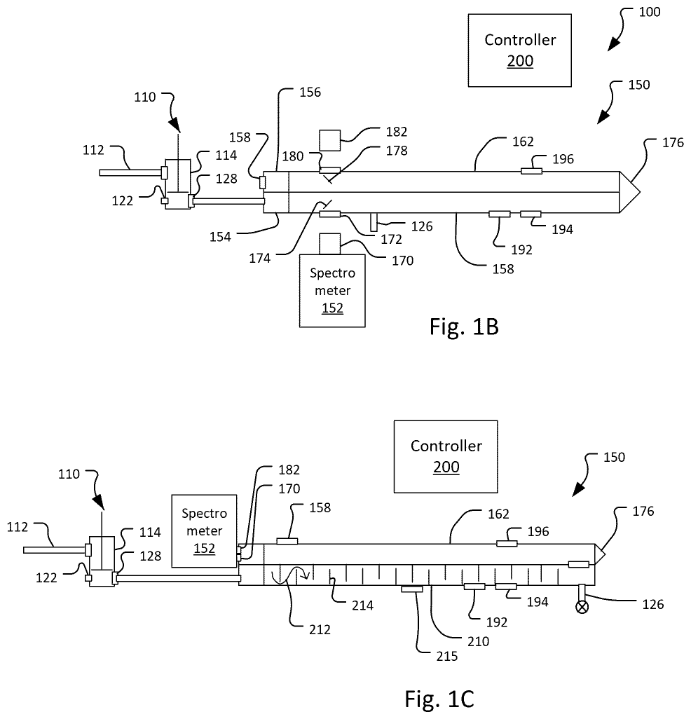

FIG. 1A shows an embodiment of an infrared absorption gas analyzer 100 that in general comprises a spectrometer 152 including a source 170 and a detector 182. The spectrometer 152 obtains the infrared absorption spectrum of gas contained in a gas cell 150. The infrared source 170 produces light in the spectral region of interest, such as 600 to 5000 cm-1. The detector 182 detects the light from the source 170 after being modulated by the sample in the gas cell 150.

In both embodiments, an analyzer gas frontend 110 prepares gas received in through an inlet port from a source 112 for insertion into the gas cell 150. A controller 200 controls the analyzer 100 and monitors the detector 182 to analyze the absorption spectra resolved by the analyzer 100 in order to identify analytes in the sample. This information is presented to the user via a display 205.

In addition, the analyzer 100 includes several sensors monitored by the controller 200. These include one or more temperature sensors 194 for monitoring the temperature of the gas in the gas cell 150 and one or more pressure sensors 192 for measuring pressure of the gas contents of the gas cell 150.

### Spectrometer Technology

The disclosed system employs different spectrometer technologies depending on cost and performance requirements.
1. Fourier transform infrared (FTIR) spectrometer—Some embodiments will employ FTIR spectrometers analyzing the sample by producing spectra in the range or part of the range of 600 to 5000 cm-1.
2. Dispersive and non-dispersive spectrometers—Other embodiments employ typically lower cost spectrometers based on sources such as thermal sources, diodes, diode arrays, or semiconductor or solid state tunable lasers. These are combined with a grating and/or spectral filters in the laser cavity to provide resolution.

One specific spectrometer includes a spatially variable bandpass filter such as a linear spatially variable bandpass filter or circular spatially variable bandpass filter and an IR broadband source. The spectrometer preferably covers the wavelength band of 2.5 to 12.5 micrometers in wavelength. A multi position, such a 3 position filter wheel, is employed in some examples that covers the spectral region of interest with 3 separate filters that are arranged to allow them to sequentially be measured in a continuous fashion.

The infrared broadband source of the spectrometer is preferably extended in its length. In some examples, the infrared source matches the length of the spatially variable bandpass filter, which is 0.25 mm by 20-25 mm. The infrared source can be a thin film source, such as silicon carbide on ceramic or other blackbody radiators to reduce heat production or a diode source. In general, the larger the infrared source, the better the signal to noise ratio, assuming that the light can be collected and detected.

In all of these technologies, the spectrometer 152 includes the source 170 for generating infrared light that is transmitted through the gas cell 150 and detected by detector 182. The spectrometer converts the response of the detector 182 into absorption spectra that are then analyzed by the controller 200.

### Gas Cell Technology

1. In some embodiments, the gas cell 150 is configured as a multiple pass gas cell including a White cell, Herriott cell or Wilks cell.
2. In the illustrated embodiment, the gas cell 150 comprises two long gas cell tubes 158, 162 in which light from the source 170 is sent down the first tube 158 and then reflected by an end reflector 176 to pass down the second tube 162 to the detector 182.

Typically, the light from infrared source 170 is collimated before and/or in the gas cell so that the light it generates passes completely through both of the tubes. In the illustrated example, the light from the source 170 is coupled into the first tube 158 through an input window 172 in the tube's side wall. The light is then reflected by a first conical mirror 174 to propagate axially in the first tube 158 to the end reflector 176. A second conical mirror couples the light propagating along the axis of the second tube 162 out through output window 180 to the detector 182 of the spectrometer 152.

In another example, the gas cell 150 is made of three plates: top, center and bottom, that are internally gold coated and then assembled length wise with an O-ring seals. The center plate will be just a gold coated plate. The top and bottom plates are two pieces that will be gold coated tubes and then snapped together with the center plate in the middle. The end reflector 176 part of the casting of the top and bottom plate, so it is all one piece.

The gas cell further preferably includes a heater 196, controlled by the controller 200 for heating the gas in the tubes to, for example, 35 degrees Celsius, to prevent condensation based on feedback from the temperature sensor 194.

In one example, the optical path length in the gas cell 150 is greater than 0.5 meters (m) but often less than 4 meters and typically about 1 meter in total optical path length. In some examples, the gas cell has two valves on either end including an input valve 154 and a backpressure valve 156 for controlling gas flows through vent port 158 to allow flow while keeping the flow cell at the desired pressure.

The analyzer gas frontend 110 includes a piston pump or other pressurization device 114 that pressurizes the ambient gas sample received through the inlet port from the source 112 to a pressure of, for example, 10 to 15 atmospheres (atm).

The gas is pressurized into a condenser 250. In the illustrated example, the gas enters into a center tube 252 that extends downward in the center of the condenser 250. Water in the pressurized gas will condense on the inner walls of the tube 252 and then flow downward to the bottom of the condenser. A drain valve 126 allows this collected water condensate to be extracted from the condenser while maintaining the pressure in the chamber. In some examples, the drain 126 is arranged such at a small pool of water is maintained in the bottom of the condenser 250 to allow for dryer subsequent samples or zero gas to be humified.

The condenser 250 is preferably surrounded by a jacket cooler 256. This can be a refrigeration unit or Peltier cooler based device. In operation, it controls the temperature of the pressurized gas in the condenser 250 and particularly removes heat to lower the gas's temperature after pressurization.

The gas then needs to flow through an output port 128 such as a restriction or one-way valve to keep the pressure high in the condenser 250 but also let flow go to the gas cell 150.

In the illustrated example, the gas exiting through output port 128 flows to a flow controller 258, such as a rotameter, that enables control of the sample flow rate by the controller 200. The gas is then directed to the gas cell 150.

A pressure sensor 260 on the line between the output port 128 and the flow controller 258 enables the controller to monitor and control the gas pressure by feedback control of the operation of the pump 114 and flow controller 258.

A path for zero gas is also provided. Specifically a known gas source, such as a cylinder of nitrogen gas 260 supplies a zero gas through a flow controller 262 and valve 264. This gas can then be passed through the pump 114 to the condenser 256 and then to the flow cell 150 to obtain a background for the spectrometer 152.

This process of passing the zero gas through the condenser 256 allows the zero gas to acquire the same level of moisture as the sample due to the water retained in the condenser, so that when the absorbance spectrum is calculated the water is effectively removed from the spectrum since it is part of the background.

FIG. 1B shows another embodiment of an infrared absorption gas analyzer.

In this example, the piston pump 114 directly feeds the sample cell 150. A pressure and temperature sensor 122 in the piston pump enable the controller to monitor the pressure and temperature of the gas provided by the pump.

In addition, a drain valve 126 is provided directly in the sample cell 150 to remove water.

Further, the gas cell 150 can be a simple tube with gas flowing down the tube to the vent port 158 at the distal end. The light goes to the end of the tube and reflects back in the same tube and the image is translated up or down. Or the image is translated to the left or the right. This would even allow the gas cell to have 1 flat mirror at the end that could be just electropolished, thus removing the need for a gold mirror, and further reducing complexity and costs.

The gas is pressurized into the gas cell where the moisture condensate can be ejected through drain valve 126 that maintains the pressure in the cell.

In one mode of operation, the drain valve is closed during compression for the background spectrum. Here also, it is desired that at least a little water is collected in the system so that when the pressure is dropped back to 1 atm to collect the background spectrum, the moisture (condensate) can vaporize and provide a saturated air sample that will match the compressed Sample. By making sure the background is saturated with moisture, this allows for the sample to be any pressure where we reach saturation using pressurized room air. A sample once fully pressurized will be at the same saturation level. During sampling the drain valve would be open to prevent liquid water from collecting in the system.

### Methods of Operation

1. The gas cell is used at a pressure that is greater than atmospheric. If ambient air has 1% moisture or water (which is common) or 7.6 Torr partial pressure. And the most water that can stay in the vapor phase at room temperature at 20 C is 17.65 Torr or 2.3%. If the pressure is raised to 15 atm piston pump, then the moisture would try to be 114 Torr (if it could stay in the vapor phase). Of course, the highest is 17.65 Torr, so the rest of the water must condense.
2. In another mode of operation, after pressurization in the piston pump, the pressure is dropped back to 1 atm in the gas cell. In this scenario, the water or moisture would be 1.17 Torr or 0.15%. Thus, the water is reduced by approximately seven-fold. This is equivalent to the vapor pressure of water at −16 C but done without the need for a chiller. This along with a gas cell of only 1 meter in total path length would allow for measurements in the water region. Carbonyl bands between 1,700-1,800 cm-1 would be visible potentially.
3. In still another mode of operation, after pressurization in the piston pump, the pressure is dropped to 5 atm (to simulate a 5 m cell-5 atm*m). In this case, the water or moisture would be 17.65/3 or 5.88 Torr partial pressure. So, the moisture would be lower than the original ambient air and there would be 5 times the molecules in the gas cell. So, the analytes of interest will appear as if they are in a 5 m cell at 1 atm, instead of 1 m cell at 5 atm. But the moisture or water will be 0.77% at 1 m, instead of 1% at 5 m if it were a 5 m cell. So, the water bands will be 6.5× smaller than running just ambient air. This mode can also handle higher moisture or water in the air, which should allow for even lower detection limits.

In this procedure the ideal pressure would be the one where water in the pressurized sample is again at 7.6 Torr. To get that level, the maximum pressure achieved is, in one example, 15 atm*7.6 torr/17.65 torr or 6.46 atm. That pressure yields 6.5× increase in the level of molecules or the equivalent of 6.5 m of sample while the water will be effectively nulled (since both sample and background) have the same moisture level.

To achieve any of these objectives to get the sample and background moisture to be the same, will probably require some level of temperature control of the sample gas cell. For instance the end reflector 176 at the one end might be heated slightly above the rest of the cell 150. Or, the area where the water collects is slightly warmed to keep the air in the chamber at saturation when the background is collected.

FIG. 1C shows another embodiment of an infrared absorption gas analyzer.

In this example, the piston pump 114 again directly feeds the sample cell 150.

Here, the gas sample from the pump 114 first enters cooling chamber 210. Preferably the cooling chamber 210 provides a tortured path 212 to the gas flow such as with a system of baffles 214.

In operation, the temperature of this cooling chamber 210 is held constant based on feedback from a temperature sensor 194 and possibly an active cooling/heating device 215 such as a Peltier cooler. The operation of this device can be reversed, however, to provide heating in certain modes.

In any event, the temperature control of the cooling chamber 210 by the controller 200 enables the control of the partial pressure of the moisture.

In one example, the gas is supplied by the pump 114 at elevated pressure such as greater than 5 atm, such as 10 atm or more. This operation will initially “wet” the walls of the cooling chamber 210 at whatever temperature the chamber is running.

The drain valve 126 is provided directly in the cooling chamber 210 to remove water.

The pressure is then dropped to 1 atm but flow rate is held constant to 1 liters per minute (lpm) to get a background spectrum at the same moisture as the sample.

Once the background is acquired, the pressure rises back to say 10 atm at 1 lpm. The flow rate is often critical to make sure both streams have equivalent partial pressure of water.

Gas enters gas cell tube 162 of the gas cell 150 at high or low pressure depending on whether a vent port 158 valve is opened on exhaust of gas cell. The gas cell may have additional heater 196 to keep the gas cell at a planned temperature, such as between 30-45 C. The Peltier heater/cooler 215 will add some heat but to keep the cell constant the additional heater 196 is often provided to prevent condensate from forming in the gas cell tube 162.

The spectrometer 152 here also includes an infrared source 170 that emits a collimated beam that is passed down and back in the gas cell tube 162. The light is returned by a retro reflector or a flat mirror 176, removing the need for expensive optics. The image of the source 170 is translated up or down, or to the left or the right. This would even allow the gas cell tube 162 to have one flat mirror at the end that could be just electropolished, thus removing the need for a gold mirror, and further reducing complexity and costs.

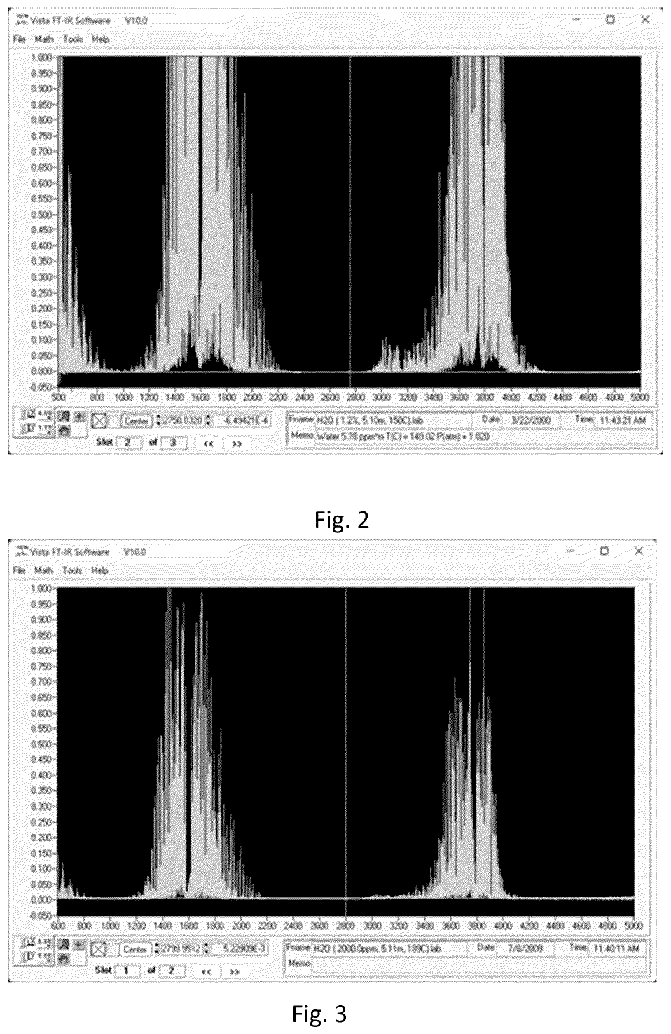

FIG. 2 shows a spectrum extending from 600 to 5000 cm-1 for a sample with 1% moisture or water in a 5 m sample cell, 5%*m. This is what ambient air would look like in an infrared gas analyzer with a 5 m cell. In addition, the spectrum would be even more dominated by water interference for an infrared gas analyzer with a 10 m cell. From 1,250-2,000 cm-1 the water interference overwhelms spectra associated with other species that have spectral signatures in this region. The region above 3,000 cm-1 where aromatic hydrocarbons absorb would also be difficult due to the water interference.

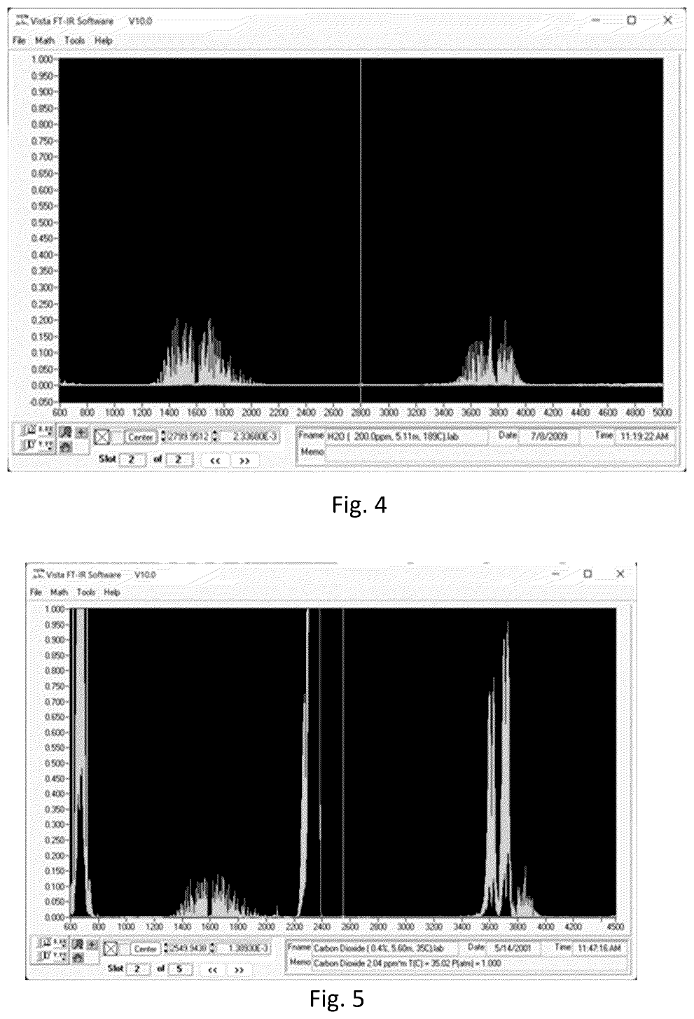

FIG. 3 shows a spectra extending from 600 to 5000 cm-1 for a sample with 1%*m of moisture or water. This is what moisture would look like with air directly to a 1 m gas cell, or approximately what it would look like if the gas is pressured and then sent to the same gas cell at a reduced pressure of 5 atm. Note how much more of the spectrum could be utilized. The region of 3,000 cm-1 could be utilized to look for aromatic hydrocarbons.

FIG. 4 shows a spectra extending from 600 to 5000 cm-1 for a sample with moisture or water of 0.1%*m on the same scale. This is what moisture would look like if pressurized and then depressurized and run at 1 atm. Clearly now regions are available that were not previously available for measurement. Now the whole spectrum could be utilized potentially. What this shows is that by using pressure it easier to see analytes of interest.

### Further Methods of Operation

1. Ambient air at 1 atm could be utilized as the background. Then the sample is analyzed at 5 atm. The data corrected by multiplying the observed concentrations by 5/4. This way most of the water is removed and in fact could be negative in the absorbance spectrum if there is high background moisture.
2. The other possibility is to have the system go to equilibrium on the moisture. The pressure is reduced until the moisture goes to zero in the absorbance spectrum.
   A. If atmospheric water is 1% or more exactly 7.6 Torr (1% of 760 Torr), then if the pressure goes up to 15 atm, the vapor pressure of water will go to 17.65 Torr, the pressure would then be dropped in the sample cell to the pressure where 7.6 Torr of water is still present. So the pressure would be dropped by 0.43 times or to 6.45 atm across the pressure release needle valve. At that point there would again have 7.6 Torr of water and the spectral features would be removed from the absorbance spectra. So, in this case we would have 6.45 atm*m of air, which is a larger atm*m level than a typical FTIR gas analyzer but with no water in the resulting absorption spectrum.
   B. In another example, the method is automated. The system collects the background spectrum and the pressure release needle valve reduces the pressure in the gas cell until the water concentration goes to zero. Then the data are pressure corrected for the delta. In this case it would be 6.45/5.45 if we started at 1 atm. Minimize the water residual to set pressure. Then if residual exceeds a predetermined absorption (abs), the system takes a new background. This would be perfect for a homeland security sensor. No rolling background required.
   C. Interestingly the sensitivity would then go up (instead of down) as the moisture in the original ambient air goes up. If there was 2% moisture in the ambient air or 15.2 Torr, the background would have 15.2 Torr of moisture. So, the pressure if raised to 15 atm would then only drop back to 13 atm (15.2 Torr/17.65 Torr×15 atm). So, the system would have twice the sensitivity as the moisture doubles. Thus, moisture should be even added some use cases.
   D. These methods enable the characterization of compounds with spectral features otherwise hidden in the moisture or water. Thus, compounds such as NOx, CH, HF, carbonyls, aromatics, CO, CO₂ etc. It should be noted with respect to detecting CO₂, it is important to address the “fingerprint” region, it might interfere and may require a specific calibration.
   E. To summarize many of the foregoing methods, once the background is collected though the pressure should remain constant, since the background spectrum is a constant. This is a key feature, once the background spectrum is collected (that spectrum is used for every future sample spectrum to calculate the absorption spectrum) it means the water we are subtracting is a constant, so the pressure would remain constant to subtract it.

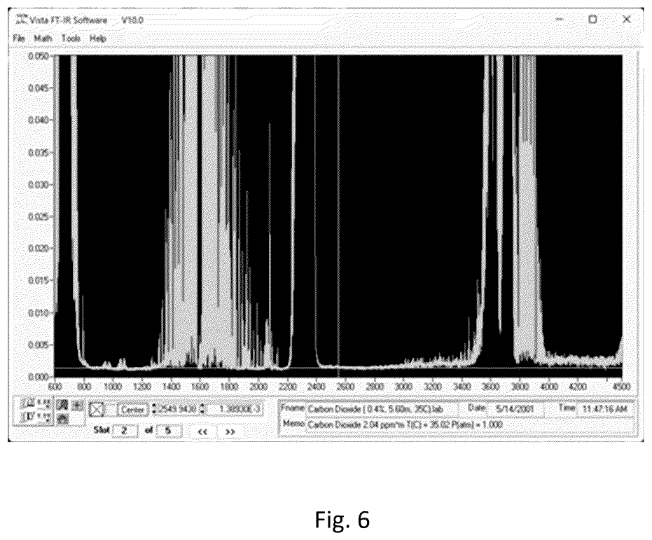

FIG. 5 shows a spectra extending from 600 to 5000 cm-1 for a sample with CO₂ at 400 ppm in ambient air (common now), at 10 atm with a 1 m pathlength, that would be 4,000 ppm*m. Here is 22,400 ppm*m of CO₂ or more than 5 times higher, so the CO₂ in the fingerprint region should not be an issue.

FIG. 6 shows a spectra extending from 600 to 5000 cm-1 for a sample with CO₂ at 400 ppm in ambient air with the Y-scale of the spectrum expanded by 20-fold. The CO₂ “Hot bands” at 900-1,100 cm-1 are less than 0.002 abs. So, worse case these peaks would be a maximum of 0.0004 abs, if the sample were run at 10 atm. A fixed calibration should be able to deal with issue.

Another issue is to deal with the filter absorbance spectra not matching the infrared library spectra. This is addressed by taking a number of spectra with this gas analyzer and comparing these spectra to the NIST library data and develop an algorithm to “deresolve” the NIST library spectra to the varying resolution. In the alternative, the gas analyzer includes a piece of polystyrene or other spectral reference that pops into the optical train to calculate the resolution throughout the spectra, since it has peaks across the whole spectral range, and then corrects either the library or sample spectra to match one another.

Another issue is variation among the filters. Then even a calibration spectra may not match from instrument-to-instrument. In the preferred implementation an instrument that is lower resolution than the calibrating instrument is employed to match the data.

On the analysis front, the analyzer should have bimodal operation. In one mode, the analyzer 100 looks for a predetermined set of compounds and does analysis for each. But as a second mode the analyzer's controller performs rapid searches of all compounds. With the whole spectrum being available, the controller is able to do a better interpretation of the spectrum.

In the application in which this gas analyzer 100 is deployed as a chemical warfare agent (CWA) sensor or ambient air monitoring for first responders, the analyzer 100 operates in a mode in which its controller very quickly searches for all CWAs and if not present just moves on or if there is another compound present, it would add the spectrum to a list of “interference spectra” so that it does not affect the analysis. In the event of a negative or positive reading for a CWA (on a subsequent spectrum), the controller 200 determines that the CWA was present in the “interference spectra”. Because the CWA and the interference gas ratios should not be constant over a short period of time.

More generally, when a spectrum is collected and it has features in it but they do not all relate to a CWA, it might be difficult to confirm the presence of the CWA. For example, assume the CWA is mixed with a solvent like methanol or isopropyl alcohol. The alcohol signature will often be many times that of the CWA. However, the alcohol vapor pressure and the CWA vapor pressures will not be constant with respect to one another. Assume that the methanol is 10× the CWA. But at some point in the near future the ratio becomes 5 to 1, if this spectra had been added to the analysis, when the methanol is removed there would be remaining CWA in the residual sample, since the ratio has changed. In this case the CWA would be positive. If the ratio went to 20 to 1, the CWA would appear to be negative. This allows for the option of adding any potential interference to the analysis and then analyzing and searching for a CWA in the next few scans. This significant potential solution prevents the analyzer from having positive and negative false readings.

In another application, the gas analyzer is deployed to analyze different types of fuels: Gasoline (ex. Types), Diesel, Jet, distillates, etc.

In some cases, it is useful to warm the gas cell, while also possibly cooling the piston pump 114 to reduce moisture further both for the background and the sample. A Peltier device is used as the heater 196 with its hot side to heat the gas cell 150 and the cold side to cool the piston pump 114. If this is the case these two devices may lay alongside each other. Reducing the piston pump temperature to 15 C from 20 C reduces the moisture even further to 13 Torr from 17.65 Torr or another 35%.

The gas cell is preferably designed so that pressure fluctuations do not change the “single beam” spectrum, otherwise there will be baseline drift. This is often a critical feature for this to work properly. In many FTIR gas analyzers, if the pressure in the gas cell changes, the single beam spectrum can change somewhat. However, if the gas cell is just one long tube (0.5 m) with a flat mirror on the opposite side, where the light goes down and comes back, it should be possible to build the tube so that the pressure does not change the shape of the tube nor change the direction of the returning beam.

Further on the subject of baseline drift, preferably, the controller 200 executes an algorithm that senses baseline drift, just like moisture spectral variances and automatically performs a new background collection.

There is one problem zeroing on air that should be addressed. What happens if the sample analyte concentration goes down. If we have a 5-fold concentration of the analyte from pressure but the concentration goes down 5-fold, the analyzer will not see the compound. If the original concentration is 10 ppm at 1 atm (that is the background of 10 ppm*atm). If the sample then drops to 2 ppm at 5 atm (again we have 10 ppm*atm), the compound will disappear into the baseline.

This problem of zeroing can be addressed a number of ways. A methodology is employed in some examples to pick up on the sample concentration variance. Another approach is to include a zeroing VOC cartridge on the front. Another approach is to direct the user to sample in a clean space before moving to the location of interest.

There is a further method for zeroing system. If the background is collected quickly and then the pressurized sample is measured directly following the background, it allows the analyzer's controller 200 to calculate both the concentration in the sample and the background by doing a pressure correction. If the concentration changes from that point forward, there is additive correction for the amount in the background. If the change is too great (to the negative—concentration is dropping) in one example, the controller 200 recommends a new background to be collected. If the initial sample reads 10 ppm at 5 atm (corrected for pressure difference), the controller deduces that the background also has 10 ppm in it at 1 atm or 10 ppm*m. So, if the analyte drops to zero in the absorbance spectrum (flat line), the controller 200 deduces that the current sample concentration is actually 2 ppm because the gas cell pressure is at 5 atm (or 10 ppm*atm) which is equivalent to the background spectrum. So, any compounds contribution to the background is the concentration divided by the pressure. In this case 10 ppm @ 1 atm/5 atm is equal to 2 ppm (equivalent). This would be added to all direct readings from the standard calibration curve stored by the controller.

This would be an idealized method, since it does not require the gas cell to be purged with N₂, clean air or filtered air. Ambient air is measured and then pressurized and measured for impurities. This is very ideal for CWA monitors in high profile buildings since there is no way to have a zero gas or a cartridge that could be contaminated.

Another possibility is if the water is well-removed, the analyzer lets it go negative and measures it that way.

In a different approach, a clean background algorithm is executed by the controller. The analyzer first collects a background and then the samples and the controller looks for any of the required compounds, if they don't show up the controller determines that it has a clean background.

In a different approach, when the analyzer has a dirty background like above (25), the controller 200 provides a notification to the user and when the level drops enough, the controller recommends a new background.

Preferably, the piston pump 114 and gas cell 150 are swappable if there is a failure or contamination issue. The idea here is these could be consumable parts that are easily swapped out. So, if the pumps are going to fail, the pump and gas cell assembly are tied together and are separate from the spectrometer part.

Lastly, how does the controller 200 co-add data to get best result. In one example, the controller 200 controls the analyzer 100 to collect each spectrum individually, quant and then do a rolling average of the results to reduce the noise. Another option is for the controller to co-add the absorbance spectra as well to show the lower noise spectrum if the user wants to do a visual inspection.

The previous discussion uses the example of a 1 m gas cell. However, in some implementations, the shorter the gas cell 150 the better because the water in the background gets smaller then. The last graphic in FIG. 6, this is what 1% water would look like if the gas cell were only 10 cm in length. This amount of water would have no effect on any measurement. The problem is that the pressure must be dropped to match this and the short pathlength. So, any absorption spectra are weak. The point is, there has to be an optimization between long and short gas cells. The cell needs to be long enough that the water peaks in the background are big enough, so the sample can be pressurized to match it. But short enough (not 5 or 10 m) such that ambient air moisture totally obscures a spectral region. This is the current problem with almost every FTIR gas analysis system on the market today. The gas cells start at about 5 m and go up to 20 to 40 m. If ambient air is around 1% the water is too intense to do analytical analysis over ½ of the sample spectrum.

The water at 1%*m is what we would normally see for ambient air at 1 m in pathlength. The water bands go up to 1.0 abs or 90% of the light absorbed. That means only 10% of the light is remaining at those frequencies. Or the SNR is 10% of the original baseline spectrum. If the gas cell had been 0.5 m, the water peaks would have dropped by about ½ to 0.5 abs (peak absorbance) for 0.5%*m. But this is still 7.6 Torr, so the pressure if raised to 15 atm, would have to drop back to 6.46 atm (see equation below) So, now we have a shorter pathlength and the analytes peaks would be ½.

At 1%*m with a 1 m cell, this seems to be optimal. This is again 7.6 Torr. So, if we pressurize this air to 15 atm. The moisture will go up to only 17.65 Torr at 20 C. So, to get the sample spectrum to match the background at 7.6 Torr, the pressure has to drop to 7.6 Torr/17.65 Torr*15 atm=6.46 atm. The pathlength is immaterial to the calculation, the only thing that matters is the partial pressure of the water. If the partial pressure of water is 7.6 Torr and the sample is then pressurized. The high pressure must be reduced by 43%. So, if that were 15 atm, it would have to drop to 6.46 atm. The higher the partial pressure the less pressure reduction. The lower the partial pressure the more the reduction.

The conclusion here is what is the most water in the gas cell for the background, so it uses most of the IR spectrum. From the sample spectra, it appears to be in the 0.5 m to 1 m pathlength since water is around 0.5 to 1.5% in most cases.

Short cells like those above also will allow for extended sources to make it through if using a filter. Again, if we have a 1 mm×25 mm detector, that has 25 times more areas than a standard 1×1 mm detector. Or 5 times higher SNR (this makes up for the 1 m path length).

FTIR spectrometers lose ⅔ of the light from the source due to the beamsplitter and modulation efficiency. It has been stated that in many cases only 10-15% of the original light intensity makes it through as a modulated beam to the sample and onto the detector. By definition 50% of the light is lost at the beamsplitter because it returns to the source. In an exemplary state of the art FTIR spectrometer, the DC and the AC component of the remaining beam reaching the detector is about equivalent, in fact the standard unit has 12.5 VDC and about 8 to 9 VAC (peak Igram). So, this means about 20% of the source is modulated and reaches the detector. (AC/Total Volts*0.5-9 V/21.5*0.5=0.20 or 20%).

So, from the two calculations above, if we can fill a 1×25 mm detector, we should have 5×5=25× more light striking the detector and being detected.

Additional conclusion. If the user does not care about most of the spectrum (compound is not in water area), then longer pathlengths again are preferred for lowering MDLs.

One interesting case point. What happens if the air is saturated at 2.3% at 20 C, or the air is warmer and is saturated. Once the analyzer starts to compress the air its moisture will start to drop out. The moisture cannot increase. The interesting thing about this point is, what=ever pressure created gives the controller the exact moisture, since at all pressures it will be 2.3% at 20 C. So, in this scenario there is no requirement to drop the pressure. The controller could obtain the background, pressurize and measure.

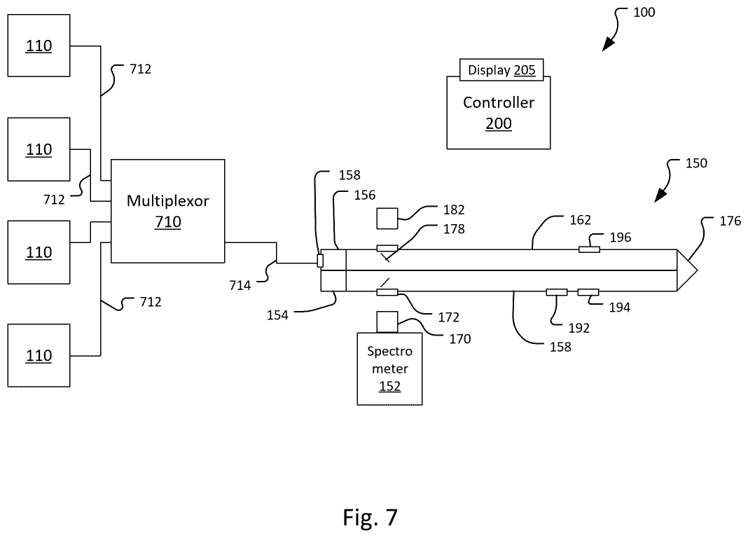

FIG. 7 shows another embodiment of the in which the analyzer front ends 110 are used in stack testing for example sample sources such as exhaust stacks. Each of these analyzer gas frontends 110 is configured as and operates as described in connection with FIG. 1A. The analyzer gas frontends 110 each send their prepared samples to a multiplexor 710 via respective transfer lines 712. The multiplexor 710 that then selectively transmits one of the samples at a time to the sample cell of the analyzer via line 714.

The advantage of this set up is that the front ends 110 can be physically remote from the multiplexor such as greater than 10 meters. Nevertheless, since the water in the sample has been reduced by the front ends 110, the transfer lines do not necessarily need to be heated.

Here, each line 712 has an analyzer front end 110 that compresses (5 to 10 atm) the sample from the stack, drying and sending the gas to the analyzer's sample cell at on line 712 at a lower pressure such as at less than 2 or even 1 atm through a cool sample line 712. These transfer lines 712 can be long, such as greater than 10 meters. Even line 714 is long and unheated in some embodiments.

The multiplexer 710 can also be cold as it selects the line for analysis. Additionally, if there were a satellite failure it could be swapped for a spare quickly.

Also, for gases that have biases due to water, the water is reduced, and it would be the same on every channel, as long as each pump for the front ends creates a similar pressure. Since every line 712 would be the same, if spiking were required or system checks required, they could be set up for the longest line. If N2 were run through as a system check, this spectrum could be added as an interference spectra into the method for all channels.

The analyzer system then could be just the analyzer and a cold multiplexer. No large heated pumps would be required. The rack of analyzers would be much smaller and could be in a classified box for safety reasons. The gas would just flow directly to the system.

While this invention has been particularly shown and described with references to preferred embodiments thereof, it will be understood by those skilled in the art that various changes in form and details may be made therein without departing from the scope of the invention encompassed by the appended claims.

What is claimed is:

1. An infrared absorption gas analyzer system comprising:
a gas cell configured to contain a gas sample;
a pump configured to adjust pressure of the gas sample;
a condenser configured to receive and cool the gas sample at elevated pressure to condense and remove water vapor from the gas sample;
a spectrometer having an infrared source and a detector arranged to measure infrared absorption of the gas sample within the gas cell; and
a controller configured to control the pump, condenser, and spectrometer to adjust and stabilize the gas sample pressure at a predetermined pressure level selected to minimize water vapor interference during infrared spectral analysis.

2. The system of claim 1, wherein the gas cell comprises two elongated gas cell tubes optically coupled by an end reflector, wherein infrared radiation from the infrared source propagates axially through a first gas cell tube, reflects from the end reflector, and propagates axially through a second gas cell tube toward the detector.

3. The system of claim 1, further comprising a temperature controller coupled to the gas cell, wherein the temperature controller is configured to maintain the gas sample within the gas cell at a controlled temperature sufficient to prevent condensation during spectral measurement.

4. The system of claim 3, further comprising:
at least one temperature sensor arranged to measure the temperature of the gas within the gas cell; and
wherein the controller is configured to control the temperature based on feedback from at least one temperature sensor.

5. The system of claim 1, further comprising a drain valve arranged at the condenser, wherein the drain valve is configured to selectively remove condensed water vapor from the condenser while maintaining elevated gas pressure within the condenser.

6. The system of claim 5, wherein the condenser comprises a central tube through which pressurized gas flows, the central tube surrounded by a cooling jacket configured to reduce the temperature of the gas sufficiently to induce condensation of water vapor onto interior walls of the central tube.

7. The system of claim 1, further comprising an input valve configured at an inlet to the gas cell and a backpressure valve configured at an outlet from the gas cell, wherein the input and backpressure valves cooperatively regulate gas flow and maintain the gas sample within the gas cell at a predetermined analysis pressure.

8. The system of claim 1, further comprising a zero gas source configured to selectively supply a zero-reference gas through the condenser and gas cell, wherein the spectrometer obtains a background infrared absorption spectrum at conditions substantially matching pressure and moisture saturation of subsequent sample measurements.

9. An infrared gas analyzer comprising:
a gas cell;
a pressure modulation device coupled to the gas cell configured to pressurize an ambient air gas sample to an elevated pressure to induce water vapor condensation;
a cooling device configured to promote condensation of water vapor from the pressurized gas sample;
an infrared spectrometer configured to measure infrared absorption spectra of the gas sample within the gas cell; and
a controller configured to coordinate operation of the pressure modulation device, cooling device, and spectrometer, wherein the second stabilized pressure is selected such that residual water vapor absorption in the infrared spectrum is reduced relative to ambient atmospheric conditions.

10. A method for infrared absorption analysis of ambient air comprising:
pressurizing an ambient air sample to a first elevated pressure sufficient to induce condensation of water vapor present in the sample;
removing condensed water vapor from the pressurized gas sample;
subsequently reducing the pressure of the gas sample to a second stabilized pressure; and
measuring infrared absorption spectra of the gas sample at the second stabilized pressure to detect trace gas analytes, wherein the second stabilized pressure is selected to substantially reduce infrared spectral interference from residual water vapor.

11. A method of analyzing gas samples by infrared absorption spectroscopy, comprising:
obtaining a background infrared absorption spectrum of an ambient air sample at a first predetermined pressure;
pressurizing a subsequent ambient air gas sample to condense and remove water vapor from the sample;
adjusting the pressure of the water-reduced gas sample within a gas cell to match the water vapor partial pressure of the ambient air sample used in obtaining the background spectrum; and
measuring an infrared absorption spectrum of the pressure-adjusted gas sample, wherein spectral features attributable to residual water vapor are minimized due to matched water vapor partial pressures between the gas sample and the background spectrum.

12. A method of analyzing gas samples by infrared absorption spectroscopy, comprising:
pressurizing an ambient air gas sample to condense and remove water vapor from the sample in a condenser;
adjusting the pressure of the water-reduced gas sample within a gas cell; and
measuring an infrared absorption spectrum of the pressure-adjusted gas sample;
passing a zero gas through the condenser to increase the water level in the zero gas;
measuring an infrared absorption spectrum of the zero gas with water; and
using the infrared absorption spectrum of the zero gas as a background to remove a signature of water from the pressure-adjusted gas sample.

13. An infrared absorption gas analyzer system comprising:
Several front ends for obtaining samples, each of the front ends including a pump configured to adjust pressure of the gas sample, and a condenser configured to receive and cool the gas sample at elevated pressure to condense and remove water vapor from the gas sample;
a spectrometer having an infrared source and a detector arranged to measure infrared absorption of the gas samples within a gas cell.

14. A system as claimed in claim 13, further comprising a multiplexor between the several front ends and the spectrometer.
